(19) United States
(12) Patent Application Publication
(10) Pub. No.: US 2023/0234892 A1
(43) Pub. Date: Jul. 27, 2023

(54) MULTI-LAYER FIBER REINFORCEMENT FOR A CERAMIC MATRIX COMPOSITE AND METHODS OF MANUFACTURING

(71) Applicant: General Electric Company, Schenectady, NY (US)

(72) Inventors: Matthew Hockemeyer, Ballston Spa, NY (US); Younkoo Jeong, Clifton Park, NY (US); Shatil Sinha, Clifton Park, NY (US)

(21) Appl. No.: 17/585,734

(22) Filed: Jan. 27, 2022

(51) Int. Cl. C04B 35/80; B32B 37/06; B32B 37/10; B32B 37/18; B32B 38/00; B28B 11/24; B28B 19/00; C04B 37/00

(52) U.S. Cl. CPC C04B 35/80; B32B 37/06; B32B 37/10; B32B 37/18; B32B 38/0036; B28B 11/243; B28B 19/0015; C04B 37/001; C04B 2235/5208

(57) ABSTRACT

A method of manufacturing a ceramic matrix composite component includes placing a first impregnated fiber layer on a surface, aligning a second impregnated fiber layer with the first impregnated fiber layer, and joining the first impregnated fiber layer with the second impregnated fiber layer at a plurality of discrete joining regions. The joining of the first and second impregnated fiber layers comprises transferring energy from at least one tool into the first and second impregnated fiber layers at the plurality of discrete joining regions.

### FIELD

The present disclosure relates to a multi-layer fiber reinforcement for use in ceramic matrix composite components and methods of manufacturing thereof.

### BACKGROUND

Manufacture of ceramic matrix composite (“CMC”) materials generally involves aligning layers of a fiber reinforcement material or layers including a fiber reinforcement layer to later be processed into a final product. Layers may be formed using sheets of reinforcement materials pre-impregnated with ceramic or pre-ceramic materials. Furthermore, ceramic or pre-ceramic materials may additionally or alternatively be added during or after alignment, or lay up, processes.

Maintaining alignment of layers typically requires adhesion between layers. For example, the materials used for pre-impregnation may serve to adhere layers to one another during later manufacturing steps. Improper adhesion between layers may lead to product defects, manufacturing difficulties, or both. If adhesion is insufficient, layers may separate during later steps, causing voids or delamination. If adhesion is too great, manual or tool handling of the layers and product in production may be impeded. Further problems may arise when the adhesion required to avoid defects is too great for easy handling. Automated processes can be particularly sensitive to unintended adhesion to automated manufacturing components. Manual processes may also be impeded by this unintended adhesion, and further impeded or made less safe by requiring general heating of the layers to achieve required adhesion.

There is a need to provide a method of manufacturing CMC materials that avoids separation of layers, voids, and other manufacturing defects while providing a safer, more reliable, and faster manufacturing process by reducing the need for material properties or processes that impede material handling.

### BRIEF DESCRIPTION OF THE DRAWINGS

The accompanying drawings, which are incorporated in and constitute a part of this specification, illustrate embodiments of the present disclosure and, together with the description, serve to explain principles of the disclosure.

FIG. 1 is a schematic sectional view of a multi-layer fiber reinforcement for a ceramic matrix composite component;

FIG. 2 is a schematic sectional view of a fiber reinforcement layer;

FIG. 3 is a schematic view of an apparatus for manufacturing a multi-layer fiber reinforcement for a ceramic matrix composite component, depicted in an open position;

FIG. 4 is a schematic view of the apparatus of FIG. 3 in a contact position;

FIG. 5 is a schematic view of a tool and associated components for joining a plurality of fiber layers of a multi-layer fiber reinforcement for a ceramic matrix composite component;

FIG. 6 is a schematic top view depicting a plurality of discrete joining regions; and

FIG. 7 is a schematic sectional side view of the plurality of discrete joining regions as in FIG. 6; and

FIG. 8 is a flow chart illustrating a method of manufacturing a multi-layer fiber reinforcement for a ceramic matrix composite component.

Other aspects and advantages of the embodiments disclosed herein will become apparent upon consideration of the following detailed description, wherein similar or identical structures may have similar or identical reference numerals.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations.

As used herein, the terms “first”, “second”, and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A technical effect of the embodiments generally shown and described herein is to enable faster, safer, cooler, more reliable, and more efficient production of ceramic matrix composite (“CMC”) materials by joining plies of material together during or following a lay-up process in a plurality of discrete joining regions. Joining plies together in this manner may reduce heat necessary to maintain appropriate adhesion and relative location of plies, thus providing greater safety to operators and increasing throughput by reducing heated thermal mass. Furthermore, low-tack or reduced-tack plies may be used to reduce undesired adhesion to operators or automated tools and equipment such as probes, arms, and rollers. Finally, localized or discrete joining may further increase throughput and reduce heat cycling of components by transmitting relatively small amounts of energy into a component at relatively high speeds, for example with the use of ultrasonic welding in a plurality of discrete joining regions.

CMC materials can include a ceramic fiber reinforcement material embedded in a ceramic matrix material. The fiber reinforcement material may include discontinuous short fibers dispersed in the matrix material or continuous fibers or fiber bundles oriented within the matrix material, and can serve as a load-bearing constituent of the CMC in the event of a matrix crack. In turn, the ceramic matrix protects the fiber reinforcement material, maintains the orientation of its fibers, and serves to dissipate loads to the reinforcement material. These CMC materials may be desirable for high temperature environments such as in a combustion section or a turbine section of a gas turbine engine. CMC materials are often useful in high temperature environments to optimize weight, strength, and dimensional stability.

Higher operating temperatures for gas turbines are continuously sought in order to increase efficiency. Though significant advances in high temperature capabilities have been achieved through formulation of iron, nickel and cobalt-base superalloys, alternative materials have also been investigated. CMC materials are a notable example because their high temperature capabilities can significantly reduce cooling air requirements. Silicon-based composites, such as silicon carbide (“SiC”) as the matrix and/or reinforcement material, are of particular interest to high-temperature applications, for example, high-temperature components of gas turbines including aircraft gas turbine engines and land-based gas turbine engines used in the power-generating industry.

As above, a CMC material may be configured as a continuous fiber reinforced CMC material. For example, suitable continuous fiber reinforced CMC materials may include, but are not limited to, CMC materials reinforced with continuous carbon fibers, oxide fibers, SiC monofilament fibers and other CMC materials including continuous fiber lay-ups and/or woven fiber preforms.

In other embodiments, the CMC material used may be configured as a discontinuous reinforced CMC material. For instance, suitable discontinuous reinforced CMC materials may include, but are not limited to, particulate, platelet, whisker, discontinuous fiber, in situ and nano-composite reinforced CMC materials. In other embodiments, the substrate may be formed from any other suitable non-metallic composite material. For instance, in an alternative embodiment, the substrate may be formed from an oxide-oxide high temperature composite material.

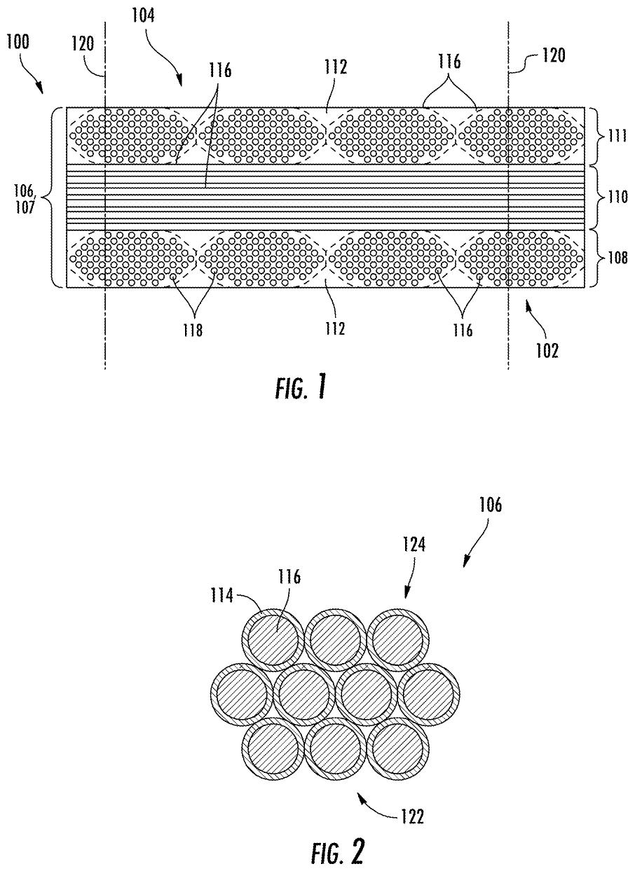

Referring now to the drawings, FIG. 1 depicts a component 100 generally defining a first surface 102 and a second surface 104 opposite the first surface 102. The portion of the component 100 depicted is formed of one or more layers of fiber material extending between the first and second surfaces 102, 104. More particularly, for the embodiment depicted, the component 100 includes a plurality of layers or plies 106 of fiber material stacked between the first and second surfaces 102, 104. Each of the plies 106 of fiber material may be configured as preformed tape material, or any other form of fiber material. Preformed tape material may be pre-impregnated with a polymer matrix material or matrix precursor such as a preceramic polymer. Such preformed tape is generally known as prepreg tape.

Notably, although the exemplary component 100 depicted in FIG. 1 includes three plies 106, comprising a first fiber layer 108, a second fiber layer 110, and a third fiber layer 111 of fiber material, in other exemplary embodiments the component 100 may be formed of any suitable number of plies 106 or layers. For example, the component 100 may be formed of two plies 106, ten or more plies 106, twenty or more plies 106, thirty or more plies 106, or any other suitable number of plies 106 comprising fiber material.

The embodiment of FIG. 1 depicts an exemplary ply stack 107 including a first fiber layer 108, a second fiber layer 110, and a third fiber layer 111. As shown, each ply stack includes a plurality of fibers 116 grouped into fiber bundles 118. However, it should be understood that individual fibers 116 are not necessarily grouped, and may be individually oriented as in woven plies 106 or various embodiments employing discontinuous and/or short fibers 116 within a ply 106. The depicted fiber bundles 118 are aligned with adjacent fiber bundles of the same ply 106 to form what may be referred to as a unidirectional ply 106 or tape. As shown, adjacent plies 106 may be configured to take advantage of varied mechanical properties by having varied relative orientations, with ply stack 107 depicted having adjacent plies 106 offset from each other by ninety degrees. Relative orientations of a ply stack 107 are tunable to achieve desired reinforcement properties in the component 100. For example, orientation of the fibers 116 may be tuned to achieve isotropic, quasi-isotropic, or anisotropic reinforcement properties both within a single ply 106 or ply stack 107.

Each of the plies may be formed by various materials. For example, each of the plies 106 may comprise silicon carbide, silicon, silica or alumina matrix materials and combinations thereof. Ceramic fibers 116 may be embedded within a matrix. As described above, fiber materials can include, but are not limited to non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof. Exemplary fiber materials include oxidation-stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAMIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y and combinations thereof) and inorganic fillers (e.g., pyrophyllite, wollastonite, mica, talc, kyanite and montmorillonite).

Further, as depicted in FIG. 1, the component 100 may include one or more layers of an interface material 112 positioned between adjacent plies 106 of fiber material. The interface material 112 may be any suitable material for providing an interface between two or more plies 106 or layers of fiber material. For example, the interface material 112 may be a matrix material as described above or a preceramic material, also referred to as a ceramic precursor or preceramic polymer. The interface material 112 may be applied in a separate step to the plies 106, for example as a slurry material spread over individual ones of the plies. Additionally or alternatively, the interface material 112 may be integral to the plies 106, for example as an impregnated material or a coating. In various embodiments, the first fiber layer 108 may be referred to as a first impregnated fiber layer, the second fiber layer 110 may be referred to as a second impregnated fiber layer, and/or the third fiber layer 111 may be referred to as a third impregnated fiber layer.

Prepreg tapes can be formed by impregnating the fiber layers 108, 110 with a slurry that contains a preceramic material, or ceramic precursor, and may further contain binding material. Preferred materials for the ceramic precursor will depend on the particular composition desired for the ceramic matrix of the component 100. For example, SiC powder and/or one or more carbon-containing materials may be preferred if the desired matrix material is SiC. Notable carbon-containing materials include carbon black, phenolic resins, and furanic resins, including furfuryl alcohol (C₄H₃OCH₂OH). Other slurry ingredients include organic binders (for example, polyvinyl butyral (PVB)) and/or plasticizers that promote the pliability of prepreg tapes, and/or solvents for the binding materials (for example, toluene, isopropanol (C₃H₈O), and/or methyl isobutyl ketone (MIBK)) that promote the fluidity of the slurry to enable impregnation of the fiber material. The slurry may further contain one or more particulate fillers intended to be present in the ceramic matrix of the component 100, for example, silicon and/or SiC powders in the case of a Si—SiC matrix.

After allowing the slurry to partially dry and, if appropriate, partially curing the binding material, or binders, the resulting prepreg tape can be laid-up with other tapes, and then debulked and, if appropriate, cured while subjected to elevated pressures and temperatures to produce a preform. The preform can then be heated, for example in a vacuum or inert atmosphere to decompose the binders, remove the solvents, and convert the preceramic material to the desired ceramic matrix material. Due to decomposition of the binders, the result may be a porous CMC body that may undergo subsequent infiltration, such as melt infiltration or chemical vapor infiltration, to fill the porosity and yield the component 100. Specific processing techniques and parameters for the above process will depend on the particular composition of the materials.

CMC materials may be tuned or tunable to achieve diverse material properties with the different constituent parts. For example, the ceramic matrix material to be formed may have a relatively high strength and Young's modulus in comparison with the fiber material. However, the fiber material may enhance the fracture toughness of the combined system by having relatively high elongation and thermal shock resistance. The individual properties of these constituent parts can work together to form a strong, stiff, and resilient component 100,

An example of a CMC material is schematically depicted in FIG. 1 as comprising the first fiber layer 108 and the second fiber layer 110, each of which may be derived from an individual prepreg tape comprising a fiber material as disclosed herein impregnated with a preceramic material as described herein. As a result, each fiber layer 108, 110 may comprise the fiber material encased in a ceramic matrix formed, wholly or in part, by conversion of the preceramic material during heating and subsequent infiltration.

The interface material 112 or a pre-impregnated ply 106 is tunable to achieve generally conflicting objects. As an illustrative example, the adhesive strength, or tack, of the interface material 112 can be increased to minimize defects or deformation in a ply stack 107 during handling or processing. Conversely, the tack of the interface material 112 can be decreased to increase ease of handling, either manually or through automated equipment, and to reduce future set or cure time.

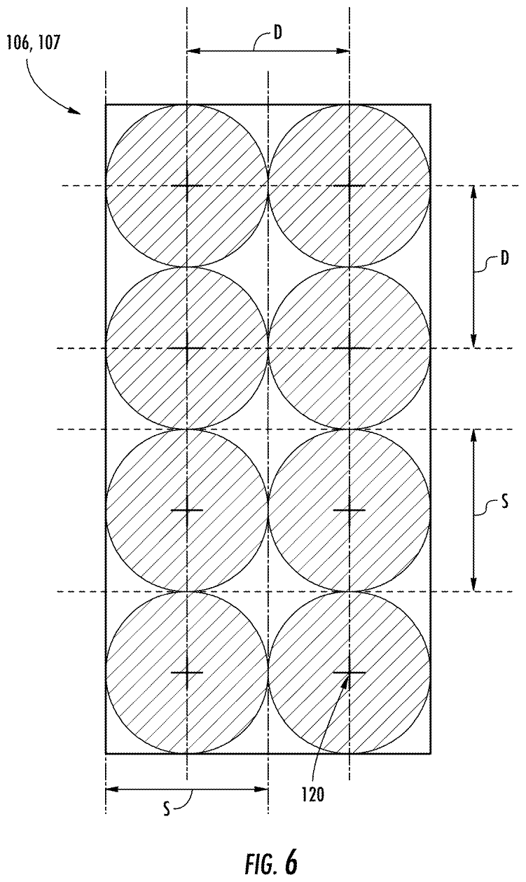

As depicted in FIG. 1, discrete connections may be formed between adjacent plies 106 at one or more discrete joining regions 120. As used herein, discrete refers to a limited select area with respect to an overall broader continuous region. Connections at a plurality of discrete joining regions 120 may facilitate a relative reduction of material tack in comparison with processes relying only on existing adhesive properties of the plies 106. In an embodiment, connections are formed at the discrete joining regions 120 through energy transfer into the discrete joining regions 120. For example, connections may be formed at the discrete joining regions 120 using an ultrasonic probe or horn, as further described below in connection with FIG. 6 to transmit energy into the ply stack 107 in the form of high frequency vibration. However, a tool or apparatus may be configured to join, fix, connect, or locate a ply stack 107 in various ways such as through localized heat transfer.

Referring now to FIG. 2, an individual one of the plies 106 is shown having a first layer surface 122 and a second layer surface 124 opposite the first layer surface 122. As shown, the first fiber layer 108 includes a plurality of aligned fibers 116. However, it should be understood that the fibers 116 may be arranged in various ways, including bundles as depicted in FIG. 1 or in multi-direction or non-directional patterns. The depicted first fiber layer 108 is not provided with a preceramic material, but may be impregnated with such before, during, and/or after being laid up with one or more further fiber layers 110, 111.

As shown in FIG. 2, the fiber material of the plies 106 may be coated prior to encasement within the ceramic matrix. For example, a coating 114 over individual ones of fibers 116 may be provided to facilitate a weak fiber-matrix interface, thus reducing, or preventing matrix material from penetrating the fiber material. Additionally or alternatively, the coating 114 may be applied to reduce degradation of the fibers 116 from handling, processing and/or harmful environmental conditions during or after manufacture. The coating 114 may serve as an interface material 112 between fiber layers 108, 110, 111 as shown in FIG. 1 independently or together with the ceramic matrix material or preceramic material.

At least one of the first layer surface 122 and the second layer surface 124 is configured to interface with another of the fiber layers 110, 111. For example, the fibers 116, the coating 114, and/or the interface material 112 may be configured to bond with an adjacent fiber layer 110, 111. In an embodiment, the first layer surface 122 of the adjacent fiber layer 110, 111 is configured to bond with an opposing second layer surface 124 of the depicted first fiber layer 108 with the application of energy, for example heat and/or vibrational energy, from an external source. In this embodiment a sufficient bond may not be achieved without application of energy from an external source. In this manner, undesirable adhesion of fiber layers 108, 110, 111 may be reduced or avoided, facilitating easier manual or automated handling and processing. Undesirable adhesion may be reduced in many ways, for example using a reduced tack preceramic material as an interface material or performing lay up of the ply stack 107 dry.

Turning now to FIG. 3, an apparatus 126 may be provided to manufacture a component 100 as described herein. The apparatus 126 may be configured to manufacture the component 100 in whole or in part, with steps that may be performed manually or through automation. In the depicted embodiment, the apparatus 126 is configured for combining a plurality of plies 106 to manufacture a ply stack 107, where the ply stack 107 is configured for use as a multi-layer fiber reinforcement of a ceramic matrix composite component 100.

The apparatus 126 is shown to include a working surface 128 configured to locate the ply stack 107. The working surface 128 can be a fixture or jig, a table, or any other suitable surface. For example, plies 106 may be assembled onto a working surface of additional plies 106. In an embodiment, the working surface 128 is configured to conform to a corresponding contour of the component 100 to be made. However, it should be understood that forming dimensions of the component 100 need not be handled by the working surface 128 and can be performed before or after this process.

The ply stack 107 assembled on the working surface 128 includes at least two plies 106 to be joined. In various embodiments, a relatively large number of plies 106 may be joined at one time. For example, 5, 10, 25, 50, or more plies 106 may be joined together to form a ply stack 107 in one process. Joining of many plies 106 may reduce heat energy build up in the ply stack 107, facilitating more efficient manufacturing, reducing heat cycling, and increasing safety. It should be understood that various process parameters such as energy, pressure, and contact time may be adjusted based on the number and thickness of plies 106 in the ply stack 107.

A tool 130 as depicted in FIG. 3 is used to contact the ply stack 107. This tool 130 may, for example, be a welding or joining tool. The tool 130 is used to contact and apply pressure to the ply stack 107 against the working surface 128. Although appropriate pressure is a variable for optimization, relatively small amounts of pressure may be required for use of the tool 130. For example, in applications where the tool 130 is handheld, the weight of the tool 130 itself may be sufficient to assure adequate contact with the ply stack 107. Appropriate pressures used could range from minimum contact pressure to 100 pounds per square inch (“PSI”). Systems and tools 130 may be configured for use within certain contact pressure ranges, for example between minimum contact pressure and 30 PSI, between 1 and 20 PSI, or between 2 and 15 PSI.

The tool 130 may be configured to contact the ply stack 107 orthogonally, for example perpendicularly, as depicted in FIGS. 3 through 5. For example, contact of the tool 130 may be made at one of the plurality of discrete joining regions 120 by moving the tool 130 towards the ply stack 107 in a direction generally orthogonal to an orientation of the ply stack 107. In this example, the tool 130 may be removed or released from the ply stack 107 by moving the tool 130 in an opposite direction generally orthogonal to the orientation of the ply stack 107. It should be understood that the tool 130 may also contact the ply stack 107 at various angles, for example at five degrees, ten degrees, or fifteen degrees off of an orthogonal contact direction.

Plies 106 of the ply stack 107 may be aligned or laid up with one another before being moved to the working surface 128 or this alignment may be performed on the working surface 128. Manual, pick and place, fully automated, or any combination of techniques may be used to place and align respective plies 106. For example, an automated machine such as a six degree of freedom robot arm may be used to lay plies 106 onto the working surface 128 and onto other plies 106.

Plies 106 to be joined with the tool 130 may be impregnated with a preceramic material prior to contact with the tool 130. For example, pre-impregnated plies 106 may be laid up on the working surface 128 or laid up to form a ply stack 107 that is then moved to the working surface 128. The plies 106 or ply stack 107 may also be impregnated with a preceramic material on the working surface 128 but prior to contact with the tool 130.

Plies 106 to be joined with the tool 130 may also be impregnated with a preceramic material after contact with the tool 130. For example, the tool 130 may act to join the plies 106 to form a ply stack 107 that is then impregnated with a preceramic material. Prior to this, the plies 106 may have no preceramic material, or may be impregnated with a relatively low amount of preceramic material to facilitate handling and processing.

The working surface 128 may be or include a release layer to aid in release after joining of the plies 106. For example, a thin release film may be applied to the working surface prior to placement of plies 106. The release layer may be reusable or sacrificial.

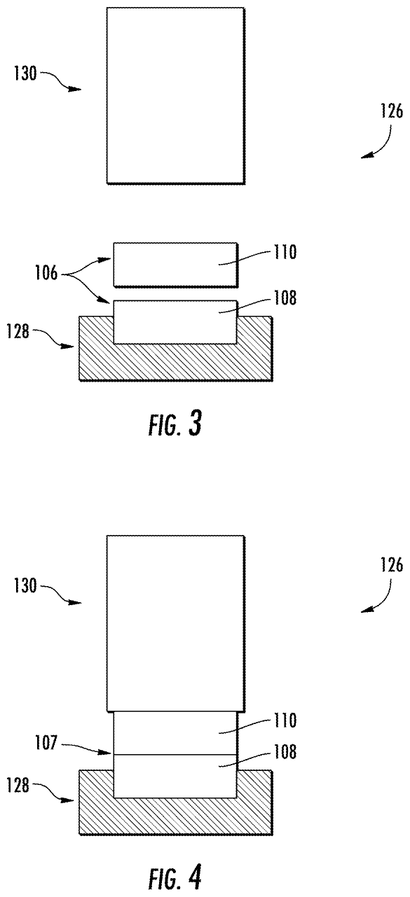

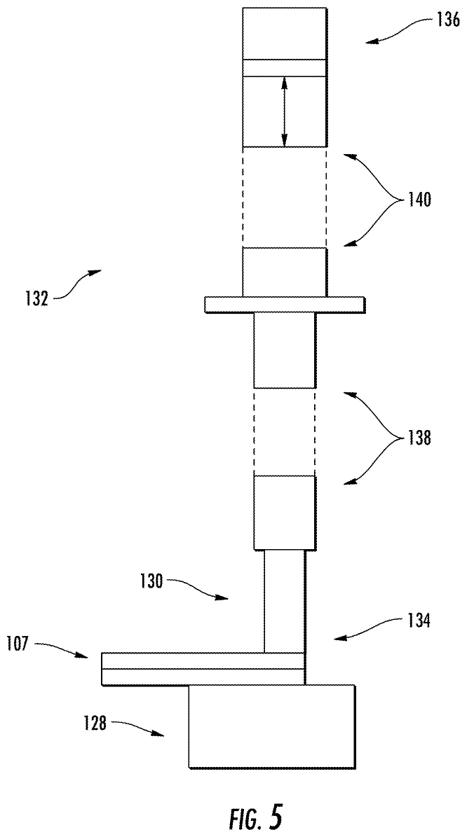

Turning now to FIG. 4, the apparatus 126 shown in FIG. 3 is now depicted in a closed or contact position where the ply stack 107 is joined by the tool 130 contacting an uppermost one of the plies 106. As above, the contact pressure of the tool 130 is tunable to achieve desired joining of the ply stack 107.

Contact time of the tool 130 with the ply stack 107 is also a variable for optimization depending on other manufacturing variables. Contact times may range from brief contact of 0.1 seconds to longer contact of 30 seconds or longer. In various embodiments, contact times may include and depend on energy transfer or weld times and on hold or set times.

Energy transfer, or weld, time may be a component of contact time as above. For example, the tool 130 may be configured to have a weld time and a hold time that together describe the contact time. The weld time is also a variable for optimization dependent on, for example, the type of energy transfer used for joining. In some embodiments, the weld time may describe the entire contact time of the tool 130 with the ply stack 107.

A hold or set time may be applied to maintain the same, reduced, or increased pressure with the tool 130 on the ply stack 107 after energy transfer has been completed. In some embodiments, a hold time may be unnecessary or undesired. In other embodiments, the hold time may make up the majority of the contact time to allow ambient cooling of the ply stack 107 after rapid heating through the joining process.

Turning now to FIG. 5, a schematic view of an embodiment of a tool 130 and associated components is shown. In this embodiment, the tool 130 is configured as part of an ultrasonic welding apparatus 132. As shown, the tool 130 may be configured as the ultrasonic welding tool, or horn, configured for contacting the ply stack 107. In this configuration, the tool 130, which may also be referred to as a sonotrode, may have a contact portion 134 configured to transmit the desired level and type of energy to the ply stack 107.

The depicted ultrasonic welding apparatus 132 includes a power supply 136 configured to provide the energy to be transmitted to the ply stack 107. The power supply 136 may include or consist of an ultrasonic generator and transducer configured to generate high frequency vibration, for example in the range of 20-40 kHz. A booster 138 is then used to amplify these vibrations.

The ultrasonic welding apparatus 132 may be manually held against the ply stack 107 with an operator applying any required pressure. Alternatively, an external component such as a robot arm may be used to locate and apply pressure to the ultrasonic welding apparatus 132. As shown in FIG. 5, the ultrasonic welding apparatus 132 may also include a pressure supply 140 configured to apply pressure to the ply stack 107 with the contact portion 134 of the tool 130. The pressure supply 140 may be an expanding device such as a linear actuator, pneumatic piston, or hydraulic piston.

The ultrasonic welding apparatus 132 may be located or locatable over the working surface 128. The ultrasonic welding apparatus 132 may also be fixed or fixable to the working surface 128, which in this case may also be referred to as an anvil.

Although the ultrasonic welding apparatus 132 is one embodiment facilitating energy transfer from the tool 130 to the ply stack 107, it should be understood that other techniques may be used for local energy transfer using the tool 130. For example, local energy transfer from the tool 130 to the ply stack 107 could implement friction joining, such as spin welding, vibration welding, or ultrasonic welding; electromagnetic joining, such as induction welding, microwave welding, resistance welding, or dielectric welding; and/or thermal joining, such as infrared welding, hot gas welding, hot plate welding, or laser welding. In various embodiments, the tool 130 may be configured as a metal probe or heated wire.

Referring now to FIG. 6, a schematic top view depicts a plurality of discrete joining regions 120. The discrete joining regions 120 may be organized in a grid pattern as shown or may be arranged in any other suitable pattern. In certain embodiments, the location, size, relative positions, and density of the plurality of discrete joining regions 120 may be a variable for optimization based on, for example, a geometry parameter of the component 100 to be produced. For example, more complex geometries may require a greater number or density of discrete joining regions 120 than a flat geometry.

Various other parameters may be used in optimization of number, position, and density of the discrete joining regions 120. In various embodiments, the density of discrete joining regions 120 may be a variable density controllable based on one or more parameters. As above, a geometry parameter, for example describing the extent to which a contour of the ply stack 107 does or will depart from flat, may be used to adjust a density of discrete joining regions 120, where more discrete joining regions 120 are provided for a geometry parameter representative of a more complex geometry. A material parameter may be used to account for the responsiveness of a material to joining, where a material parameter representative of a material with relatively high adhesion needing less additional joining can facilitate a lower density or fewer discrete joining regions 120. A process parameter may also be used to adjust a density of joining regions 120. For example, a process parameter representative of a lower process temperature may require a greater density or number of joining regions 120.

As shown, the relative positioning of discrete joining regions 120 may be described by distances D on the ply stack 107, where the distance D is measured between centers following the contours of the ply stack 107. The distance D may be variable, for example to adjust density of discrete joining regions 120 as described above.

Relative positioning of discrete joining regions 120 may further be described by one or more joining region dimensions S. For example, the embodiment of FIG. 6 depicts a circular discrete joining region 120 having a joining region dimension S describing a diameter of the joining region. However, it should be understood that the joining region dimension S is not necessarily uniform within or between discrete joining regions 120. The extent of the joining region dimension S may be determined by the extent of local energy transfer sufficient to create joining or additional joining of plies 106 of the ply stack 107. The extent of local energy transfer may be tunable to achieve desired properties. For example, the discrete joining regions 120 may be formed with an amount of local energy transfer sufficient to increase the tack of the plies 106 of the ply stack 107 but insufficient to convert preceramic material of the plies 106 into ceramic material.

FIG. 6 depicts an embodiment where the joining region dimension S is equal to the distance D between centers of neighboring discrete joining regions 120. However, it should be understood that the joining region dimension D may be adjusted independent of the joining region dimension S. In some embodiments, the joining region dimension S may be greater than the distance D, leading to overlap of discrete joining regions 120. However, to maintain discrete joining regions 120, complete overlap of all discrete joining regions 120 is avoided. In some embodiments, the joining region dimension S is less than the distance D, leading to space between adjacent discrete joining regions 120.

The joining region dimension S may be tunable by adjusting energy transfer from the tool 130 to the discrete joining regions 120. For example, less energy transfer will result in a smaller joining region dimension S if all other variables are held constant. Energy transfer may be widely variable depending on process parameters and is a further variable for optimization. In an embodiment using ultrasonic welding as in FIG. 5, energy applied by the tool 130 to an individual joining region may be in the range of 1 Joule to 200 Joules. For example, the tool may be configured to operate in ranges between 5 Joules to 150 Joules, between 10 Joules and 50 Joules, or between 10 Joules and 30 Joules. It should be understood that weld time and tool power may each be adjusted to adjust tool energy. The energy applied by the tool 130 may be selected to achieve adequate adhesion between adjacent plies 106 of the ply stack 107 by increasing the tack of one or more of the plies 106. For example, a relatively low tack ply 106 with otherwise inadequate adhesion properties may achieve adequate adhesion with an adjacent ply 106 of the ply stack 107 through this energy application by the tool 130. The tool 130 may also be configured to limit the amount of energy transferred, for example to avoid conversion of a preceramic material of one or more impregnated plies 106 to form a ceramic matrix.

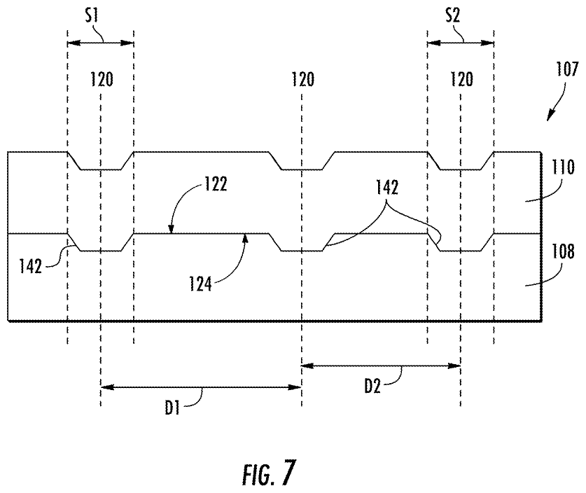

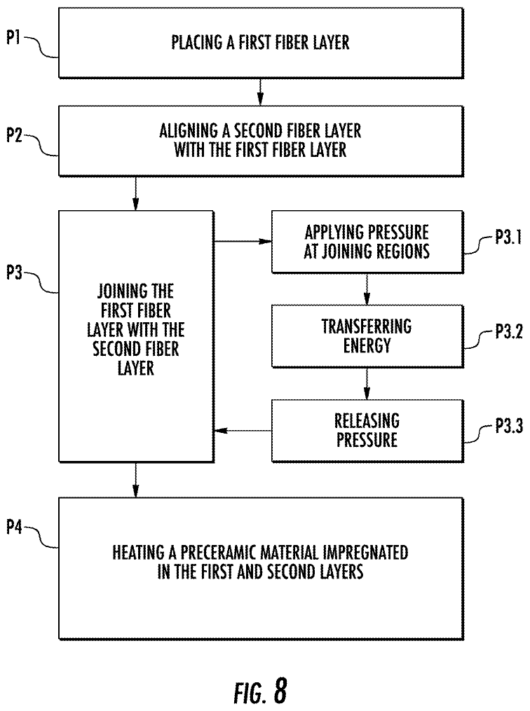

FIG. 7 is a schematic sectional side view of the plurality of discrete joining regions as in FIG. 6 but according to a different embodiment. FIG. 7 differs from FIG. 6 in that a first distance D1 between centers of adjacent discrete joining regions 120 is depicted as distinct from a second distance D2. Additionally, a first joining region dimension S1 is depicted as distinct from a second joining region dimension S2. As described above, these distances and dimensions may be individually adjusted and optimized.

Furthermore, FIG. 7 depicts a plurality of joining features 142 corresponding to the plurality of discrete joining regions 120. The joining features 142 may be any features facilitating a discrete joint between adjacent first and second fiber layers 108, 110. For example, the joining features 142 may be ultrasonic weld joints as formed with the apparatus depicted in FIG. 5. It should be appreciated that the joining features may additionally or alternatively be of various other configurations, such as friction, thermal, and/or electromagnetic joints as described above with reference to FIG. 5. The joining features 142 may be identifiable by local deformation or rearrangement of fibers 116 or fiber bundles 118. The joining features 142 may also be complementary or interlocking features. For example, a depression of the first layer surface 122 of a fiber layer 108 may correspond with an expansion of the second layer surface 124 of a further fiber layer 110 as depicted in FIG. 7.

Turning now to FIG. 8, a flow chart illustrating a method of manufacturing a multi-layer fiber reinforcement for a ceramic matrix composite component is depicted. This method can be applied to form a component 100 as described above.

The first process (P1) depicted is placing a first fiber layer 108. In this process P1, the first fiber layer 108 can be placed onto the working surface 128. Such placement may be automatic or manual. It should be understood that although the working surface 128 may be the surface onto which the first fiber layer 108 is placed, this working surface 128 may be or may include further joined or un-joined fiber layers. The working surface 128 may also include a release layer as described above.

In the second process (P2), aligning a second fiber layer 110 with the first fiber layer 108 is performed. This process may also be automatic or manual. It should be understood that the first and second fiber layers 108, 110 may be pre-impregnated with preceramic material prior to this process.

In the third process (P3), joining the first fiber layer 108 with the second fiber layer 110 is performed at a plurality of discrete joining regions 120. Again, each step may be performed manually, through automation, or with a combination of techniques. This process is described in more detail with reference to its sub-processes below.

In the first sub-process (P3.1), applying pressure, with at least one tool 130, to the second fiber layer 110 at the plurality of discrete joining regions is performed. The contact pressure may be of varying degree as described above and may be manually or automatically applied. This contact pressure is applied to the uppermost layer in the ply stack 107 to apply sufficient pressure to the ply stack 107 as a whole. It should be understood that contact pressure may be adjusted based on a number or thickness of plies 106 in the ply stack 107.

A contact area of the tool 130 or its contact portion 143 with the ply stack 107 may be a small, generally contiguous area. For example, the contact portion 143 of the tool 130 may be in the range of ⅛ inch to 1 inch. The contact portion 143 of the tool 130 may also have one or more surface features (not shown), for example to facilitate release of the ply stack 107 or to conform to a contour of the ply stack 107, working surface 128, and/or desired component 100.

A ratio of total joined area of the plurality of discrete joining regions 120 to a corresponding layer area of the second fiber layer 110 or ply stack 107 may also be defined. In exemplary embodiments, this ratio may be relatively small; for example less than 50%, less than 20%, or less than 10% of the total area of the ply stack 107.

Contact force of the tool 130 may be regulated, for example with the power supply 136 as shown in FIG. 5. Furthermore, an independent regulator may be provided to regulate a contact force between the tool 130 and the ply stack 107. For example, a transducer and a processor may be provided to facilitate automated contact force regulation.

The process depicted may use a tool 130 to contact a plurality of independent contiguous areas at once or one at a time. For example, the tool 130 could be configured with a plurality of contact portions 134 configured to independently contact discrete individual joining regions 120.

Turning now to the second sub-process (P3.2), transferring energy from the at least one tool 130 into the first and second fiber layers 108, 110 is performed at the plurality of discrete joining regions 120. As above, it should be understood that such energy transfer may be used to join two, three, ten, or any number of fiber layers. In certain embodiments, the energy used at any one of the discrete joining regions 120 is less than 100 Joules, and could be restricted to less than 50 Joules or less than 20 Joules in further embodiments.

Ultrasonic welding, as described above, can use a tool 130 configured as an ultrasonic horn to transfer energy in the form of ultrasonic vibration into the fiber layers 108, 110, 111. This energy transfer may occur in any pattern. For example, it may be continuous or pulsed.

Turning to the third sub-process (P3.3), releasing the at least one tool 130 from the plurality of discrete joining regions 120 is performed. This release may be performed after one or more intermediate steps including a hold, set, or cure time as described above.

Following this third sub-process (P3.3), the tool 130 may be moved to a new location after this to repeat the process at a further discrete joining region 120. As above, movement of the tool 130 may be manual and may be facilitated by an automated tool holder, a press assembly, a gantry, and/or a robot arm. Multiple tools 130 may be provided so that the third process (P3) need not be repeated as many times or at all. In an embodiment, a first ultrasonic horn configuration of the tool 130 is used for joining a first joining region of the plurality of discrete joining regions 120 and a second ultrasonic horn configuration of the tool 130 is used for joining a second joining region of the plurality of discrete joining regions 130. Furthermore, multiple tools 130 may be configured to perform the third process (P3) simultaneously, staggered, or in any order.

Further processes may be included at any point. For example, an additional process of moving the ply stack 107 to an autoclave or other heating facility may be added between processes (P3) and (P4).

In the fourth process (P4), heating a preceramic material impregnated within the joined first and second fiber layers 108, 110 is performed such that at least a portion of the preceramic material converts to form a ceramic matrix. In this step, the component 100 may be fully formed or may be ready for further processing. For example, the ply stack 107 may require further impregnation and heating to achieve desired material qualities. Once these material qualities are achieved, final machining or processing can be used to arrive at the final component 100.

The apparatus 126, component 100, and constituent parts thereof may be provided with any of the features and elements as shown and described. The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the disclosure or of what may be claimed, but rather as descriptions of features specific to particular embodiments of the disclosure. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

It is intended that the foregoing detailed description be regarded as illustrative rather than limiting and that it is understood that the following claims including all equivalents are intended to define the scope of protection. The claims should not be read as limited to the described order or elements unless stated to that effect. Therefore, all embodiments that come within the scope and spirit of the following claims and equivalents thereto are claimed.

Further aspects are provided by the subject matter of the following clauses:

One aspect provides a method of manufacturing a ceramic matrix composite component, the method comprising: placing a first impregnated fiber layer on a surface; aligning a second impregnated fiber layer with the first impregnated fiber layer; and joining the first impregnated fiber layer with the second impregnated fiber layer at a plurality of discrete joining regions, wherein the joining comprises transferring energy from at least one tool into the first and second impregnated fiber layers at the plurality of discrete joining regions.

Another aspect provides heating a preceramic material impregnated within the joined first and second impregnated fiber layers such that at least a portion of the preceramic material converts to form a ceramic matrix.

Yet another aspect provides that the joining further comprises: applying pressure, with the at least one tool, to the second impregnated fiber layer at the plurality of discrete joining regions; and releasing the at least one tool from the plurality of discrete joining regions.

Yet another aspect provides that each of the first impregnated fiber layer and the second impregnated fiber layer is pre-impregnated with a preceramic material.

Yet another aspect provides that transferring energy from the at least one tool is configured to increase a tack of the first impregnated fiber layer and/or the second impregnated fiber layer and is further configured to avoid conversion of the preceramic material to form a ceramic matrix.

Yet another aspect provides that the surface comprises at least one further impregnated fiber layer.

Yet another aspect provides that the joining further comprises transferring energy from the at least one tool into the at least one further impregnated fiber layer.

Yet another aspect provides that the at least one tool comprises an ultrasonic horn and wherein transferring energy from the at least one tool into the first and second impregnated fiber layers comprises transmitting a pulse of ultrasonic vibration with ultrasonic horn to the second impregnated fiber layer.

Yet another aspect provides regulating, with a regulator of the at least one tool, a contact force of the ultrasonic horn with the second impregnated fiber layer.

Yet another aspect provides contacting, with the ultrasonic horn, a contiguous area of the second impregnated fiber layer no greater than one square inch.

Yet another aspect provides that the contiguous area of the second impregnated fiber layer is at least one eighth of an inch.

Yet another aspect provides that the at least one tool is configured to transfer less than two hundred Joules (200 J) of energy to each of the plurality of discrete joining regions.

Yet another aspect provides that the plurality of discrete joining regions together comprises a total joined area, wherein the total joined area is less than fifty percent (50%) of a corresponding layer area of the second impregnated fiber layer.

Yet another aspect provides that the total joined area is less than ten percent (10%) of the corresponding layer area.

Yet another aspect provides positioning, with an automated tool holder, the at least one tool into a first position corresponding to a first joining region of the plurality of discrete joining regions and into a second position corresponding to a second joining region of the plurality of discrete joining regions.

Yet another aspect provides controlling, with a processor, a variable density of the plurality of discrete joining regions based at least in part on at least one of: a geometry parameter; a material parameter; or a process parameter.

Yet another aspect provides that at least one of the first impregnated fiber layer and the second impregnated fiber layer comprises a fiber material, the fiber material having a lower Young's modulus than a matrix material of the ceramic matrix.

Yet another aspect provides that the first impregnated fiber layer and second impregnated fiber layer are formed of the same material.

Yet another aspect provides joining, with a first ultrasonic horn of the at least one tool, a first joining region of the plurality of discrete joining regions; and joining, with a second ultrasonic horn of the at least one tool, a second joining region of the plurality of discrete joining regions.

Yet another aspect provides a multi-layer fiber reinforcement for forming a ceramic matrix composite component, the multi-layer fiber reinforcement comprising: a first fiber layer pre-impregnated with a first preceramic material, the first fiber layer comprising a first fiber material; a second fiber layer disposed on the first fiber layer, the second fiber layer pre-impregnated with a second preceramic material and comprising a second fiber material; and a plurality of joining features formed between the first fiber layer and the second fiber layer, the plurality of joining features configured to locate the first fiber layer relative to the second fiber layer.

We claim:

1. A method of manufacturing a ceramic matrix composite component, the method comprising:
placing a first impregnated fiber layer on a surface;
aligning a second impregnated fiber layer with the first impregnated fiber layer; and
joining the first impregnated fiber layer with the second impregnated fiber layer at a plurality of discrete joining regions, wherein the joining comprises transferring energy from at least one tool into the first and second impregnated fiber layers at the plurality of discrete joining regions.

2. The method according to claim 1, further comprising:
heating a preceramic material impregnated within the first and second impregnated fiber layers such that at least a portion of the preceramic material converts to form a ceramic matrix.

3. The method according to claim 1, wherein the joining further comprises:
applying pressure, with the at least one tool, to the second impregnated fiber layer at the plurality of discrete joining regions; and
releasing the at least one tool from the plurality of discrete joining regions.

4. The method according to claim 1, wherein each of the first impregnated fiber layer and the second impregnated fiber layer is pre-impregnated with a preceramic material.

5. The method according to claim 4, wherein transferring energy from the at least one tool is configured to increase a tack of the first impregnated fiber layer and/or the second impregnated fiber layer and is further configured to avoid conversion of the preceramic material to form a ceramic matrix.

6. The method according to claim 1, wherein the surface comprises at least one further impregnated fiber layer.

7. The method according to claim 6, wherein the joining further comprises transferring energy from the at least one tool into the at least one further impregnated fiber layer.

8. The method according to claim 1, wherein the at least one tool comprises an ultrasonic horn and wherein transferring energy from the at least one tool into the first and second impregnated fiber layers comprises transmitting a pulse of ultrasonic vibration with the ultrasonic horn to the second impregnated fiber layer.

9. The method according to claim 8, further comprising regulating, with a regulator of the at least one tool, a contact force of the ultrasonic horn with the second impregnated fiber layer.

10. The method according to claim 8, further comprising contacting, with the ultrasonic horn, a contiguous area of the second impregnated fiber layer no greater than one square inch.

11. The method according to claim 10, wherein the contiguous area of the second impregnated fiber layer is at least one eighth of an inch.

12. The method according to claim 10, wherein the at least one tool is configured to transfer less than two hundred Joules (200 J) of energy to each of the plurality of discrete joining regions.

13. The method according to claim 1, wherein the plurality of discrete joining regions together comprises a total joined area, wherein the total joined area is less than fifty percent (50%) of a corresponding layer area of the second impregnated fiber layer.

14. The method according to claim 13, wherein the total joined area is less than ten percent (10%) of the corresponding layer area.

15. The method according to claim 1, further comprising positioning, with an automated tool holder, the at least one tool into a first position corresponding to a first joining region of the plurality of discrete joining regions and into a second position corresponding to a second joining region of the plurality of discrete joining regions.

16. The method according to claim 15, further comprising controlling, with a processor, a variable density of the plurality of discrete joining regions based at least in part on at least one of:
a geometry parameter;
a material parameter; or
a process parameter.

17. The method according to claim 1, wherein at least one of the first impregnated fiber layer and the second impregnated fiber layer comprises a fiber material, the fiber material having a lower Young's modulus than a matrix material of the ceramic matrix.

18. The method according to claim 1, wherein the first impregnated fiber layer and second impregnated fiber layer are formed of the same material.

19. The method according to claim 1, wherein the joining further comprises:
joining, with a first ultrasonic horn of the at least one tool, a first joining region of the plurality of discrete joining regions; and
joining, with a second ultrasonic horn of the at least one tool, a second joining region of the plurality of discrete joining regions.

20. A multi-layer fiber reinforcement for forming a ceramic matrix composite component, the multi-layer fiber reinforcement comprising:
a first fiber layer pre-impregnated with a first preceramic material, the first fiber layer comprising a first fiber material;
a second fiber layer disposed on the first fiber layer, the second fiber layer pre-impregnated with a second preceramic material and comprising a second fiber material; and
a plurality of joining features formed between the first fiber layer and the second fiber layer, the plurality of joining features configured to locate the first fiber layer relative to the second fiber layer.
